(19) United States
(12) Patent Application Publication
(10) Pub. No.: US 2012/0049577 A1
(43) Pub. Date: Mar. 1, 2012

(54) INDEPENDENT OPPOSING-HINGED ACCESS DOOR

(75) Inventors: Bob Thomas, Thousand Oaks, CA (US); Jussi A. Timonen, Los Angeles, CA (US); Niki J. Smart, Marina Del Rey, CA (US); Frank Saucedo, Westlake Village, CA (US)

(73) Assignee: GM GLOBAL TECHNOLOGY OPERATIONS, INC., Detroit, MI (US)

(21) Appl. No.: 12/870,886

(22) Filed: Aug. 30, 2010

(51) Int. Cl. B60J 5/04; E05F 15/00; E05F 11/54

(52) U.S. Cl. 296/202; 49/358; 296/146.11

(57) ABSTRACT

A vehicle includes a pair of opposing-hinged doors having a first door and a second door. The first door includes a first edge and a second edge, and is moveable between a closed position, an intermediate position and an open position. The vehicle includes a slideable hinge assembly that moves laterally relative to a longitudinal axis of a body of the vehicle to move the second edge of the first door laterally away from the body and move the first edge parallel with the longitudinal axis and away from the second door when the first door moves from the closed position into the intermediate position. Once in the intermediate position, the first door is free to swing into the open position independently of the second door.

### TECHNICAL FIELD

The invention generally relates to a vehicle having opposing-hinged doors, and more specifically to a first door of the vehicle that opens independently of a second door of the vehicle.

### BACKGROUND

Opposing-hinged doors on vehicles include a first door and a second door arranged on the same side of the vehicle, longitudinally adjacent to each other, with the first door disposed nearer a second end of the vehicle than the second door. Each of the opposing-hinged doors pivots open in an opposite direction. More specifically, the first door includes a forward edge disposed nearer the first end of the vehicle and a rearward edge disposed nearer the second end of the vehicle. The first door is hinged along the rearward edge of the first door, and pivots open in a first pivot direction such that the forward edge of the first door swings away from the vehicle when opening the first door and toward the vehicle when closing the first door. The second door also includes a forward edge disposed nearer the first end of the vehicle and a rearward edge disposed nearer a second end of the vehicle. The second door is hinged along the forward edge of the second door, and pivots in a second pivot direction, which is opposite the first pivot direction, such that the rearward edge of the second door swings away from the vehicle when opening the second door and toward the vehicle when closing the second door. Accordingly, the first door and the second door open and close in opposite directions.

Opposing-hinged doors may not include a body pillar disposed between the first door and the second door. When no body pillar exists between the first door and the second door, the first door and the second door are arranged immediately adjacent each other in sealing engagement. Typically, the opposing-hinged doors are arranged such that the more forward door, i.e., the second door, must be opened prior to and in order to open the more rearward door, i.e., the first door. In other words, opening the more rearward first door is dependent upon opening the more forward second door beforehand.

### SUMMARY

A vehicle is provided. The vehicle includes a body, and a hinge assembly attached to the body. A first door is attached to the hinge assembly. The first door is moveable between a closed position, an intermediate position and an open position. The first door includes a first edge and a second edge disposed opposite the first edge. The first door is attached to the hinge assembly adjacent the second edge of the first door. The first door is disposed substantially parallel with a longitudinal axis of the body when in the closed position. The second edge of the first door moves laterally away from the body into a pivot position and the first edge moves parallel with the longitudinal axis when the first door moves between the closed position and the intermediate position. The first door pivots about a primary pivot axis such that the first edge of the first door swings laterally away from the body when the first door moves from the intermediate position into the open position.

A vehicle also provided. The vehicle includes a body including a first end and a second end. The second end is disposed opposite the first end along a longitudinal axis of the body. A hinge assembly is attached to the body. The hinge assembly is slideably moveable relative to the body in a lateral direction relative to the longitudinal axis of the body. A first door is attached to the hinge assembly. The first door is moveable between a closed position, an intermediate position and an open position. The first door includes a first edge and a second edge disposed opposite the first edge. The first door is attached to the hinge assembly adjacent the second edge of the first door, and is pivotable in a first pivot direction. A second door is disposed adjacent the first door and pivotably attached to the body for pivotable movement in a second pivot direction. The second pivot direction is opposite the first pivot direction. The second door is disposed nearer the first end of the body than the first door and the first door is disposed nearer the second end of the body than the second door. The first door is disposed substantially parallel with the longitudinal axis of the body when the first door is in the closed position. The second edge of the first door moves laterally away from the body into a pivot position, and the first edge moves parallel with the longitudinal axis and away from the second door when the first door moves from the closed position into the intermediate position. The first door pivots about a primary pivot axis such that the first edge of the first door swings laterally away from the body when the first door moves from the intermediate position into the open position.

Accordingly, movement from the closed position into the intermediate position moves the second edge of the first door laterally away from the body, which simultaneously draws the first edge of the first door along and parallel with the longitudinal axis of the body. This movement into the intermediate position from the closed position allows the first door to move longitudinally away from the second door. Once in the intermediate position, the first door is free to rotate into the open position. Accordingly, the first door may open independently of the second door.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic top plan view of a vehicle.

FIG. 2 is a schematic perspective view of a first door in a closed position shown from a interior of the vehicle.

FIG. 3 is a schematic perspective view of the first door in an intermediate position shown from the interior of the vehicle.

FIG. 4 is a schematic perspective view of the first door in an open position shown from the interior of the vehicle.

FIG. 5 is a schematic exploded perspective view of the first door and a hinge assembly of the vehicle.

FIG. 6 is a schematic perspective view of a latch guide and a latch pin of the vehicle, with the latch pin shown in a latched position.

FIG. 7 is a schematic perspective view of the latch guide and the latch pin when the first door is in the intermediate position and the latch pin is in the latched position.

FIG. 8 is a schematic perspective view of the latch guide and the latch pin, with the latch pin shown in an unlatched position.

### DETAILED DESCRIPTION

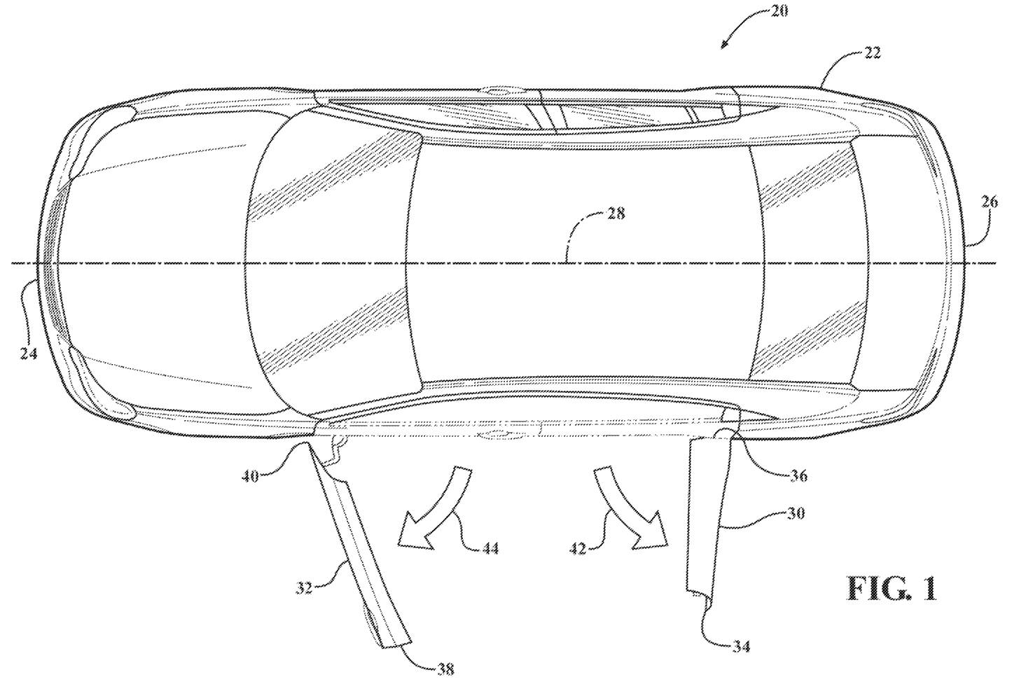

Referring to the Figures, wherein like numerals indicate like parts throughout the several views, a vehicle is shown generally at 20. Referring to FIG. 1, the vehicle 20 includes a body 22. The body 22 may include a frame and any structural support elements attached thereto, as well as the outer sheet metal coverings attached to the frame and/or structural elements of the vehicle 20.

The body 22 includes a first end 24 and a second end 26. The second end 26 of the body 22 is disposed opposite the first end 24 along a longitudinal axis 28 of the body 22. As shown, the first end 24 of the vehicle 20 includes a front of the vehicle 20. However, the first end 24 of the vehicle 20 is not limited to the front of the vehicle 20. As shown, the second end 26 includes a back end of the vehicle 20. However, the second end 26 of the vehicle 20 is not limited to the back of the vehicle 20. The longitudinal axis 28 extends between the first end 24 and the second end 26 of the vehicle 20.

The vehicle 20 further includes a first door 30 and a second door 32. The first door 30 and the second door 32 are disposed on the same side of the vehicle 20, adjacent each other. As shown, the first door 30 disposed nearer the second end 26 of the body 22 than the second door 32, and the second door 32 is disposed nearer the first end 24 of the body 22 than the first door 30. However, it should be appreciated that the positions of the first door 30 and the second door 32 relative to the first end 24 and the second end 26 of the vehicle 20 may be reversed from that shown in the Figures.

The first door 30 includes a first edge 34 and a second edge 36. The second edge 36 of the first door 30 is disposed opposite the first edge 34 along a longitudinal axis 28 of the body 22 when the first door 30 is closed. Accordingly, the first edge 34 and the second edge 36 of the first door 30 define a forward edge and a rearward edge of the first door 30 respectively. As shown, the first edge 34 of the first door 30 is disposed nearer the first end 24 of the body 22 than the second edge 36 of the first door 30, and the second edge 36 of the first door 30 is disposed nearer the second end 26 of the body 22 than the first edge 34 of the first door 30. However, it should be appreciated that the positions of the first edge 34 and the second edge 36 of the first door 30 may be reversed from that shown in the Figures.

The second door 32 is pivotably attached to the body 22. The second door 32 includes a first edge 38 and a second edge 40. The first edge 38 of the second door 32 is disposed opposite the second edge 40 along the longitudinal axis 28 of the body 22 when the second door 32 is closed. Accordingly, the first edge 38 and the second edge 40 of the second door 32 define a forward edge and a rearward edge of the second door 32. As shown, the first edge 38 of the second door 32 is disposed nearer the second end 26 of the body 22 than the second edge 40 of the second door 32, and the second edge 40 of the second door 32 is disposed nearer the first end 24 of the body 22 than the first edge 38 of the first door 30. However, it should be appreciated that the positions of the first edge 38 and the second edge 40 of the second door 32 may be reversed from that shown in the Figures.

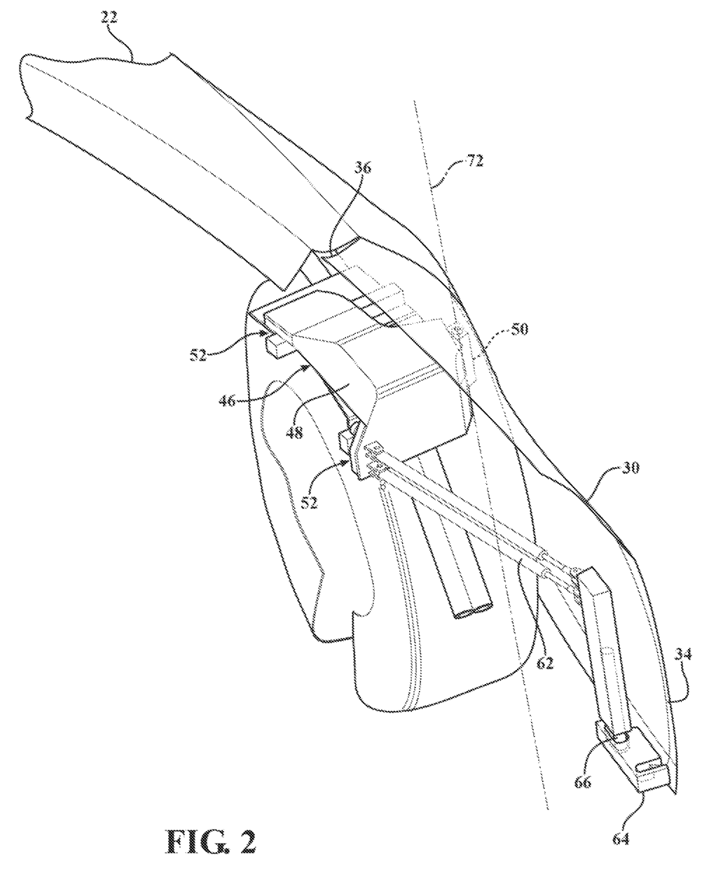

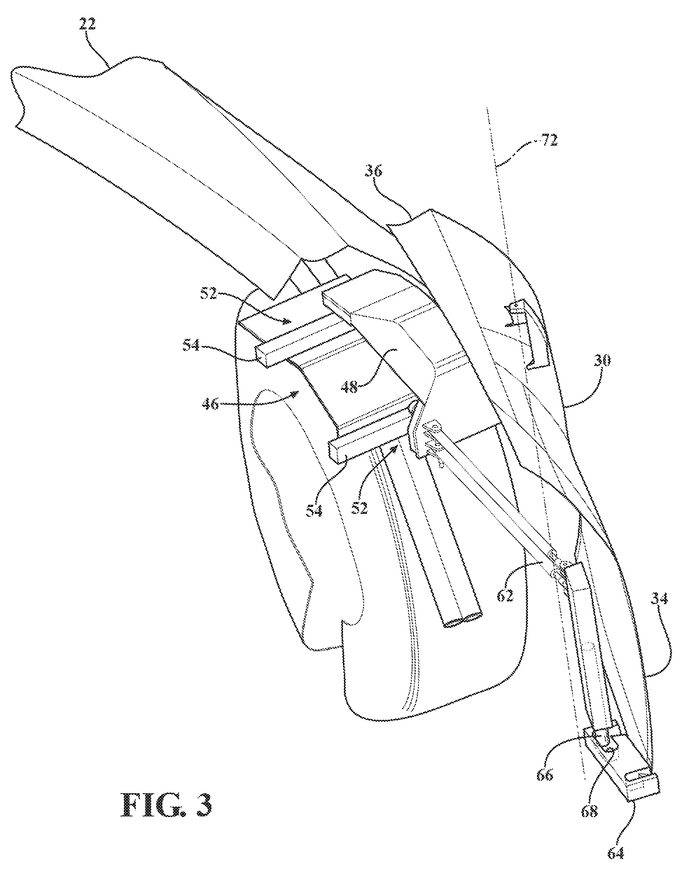

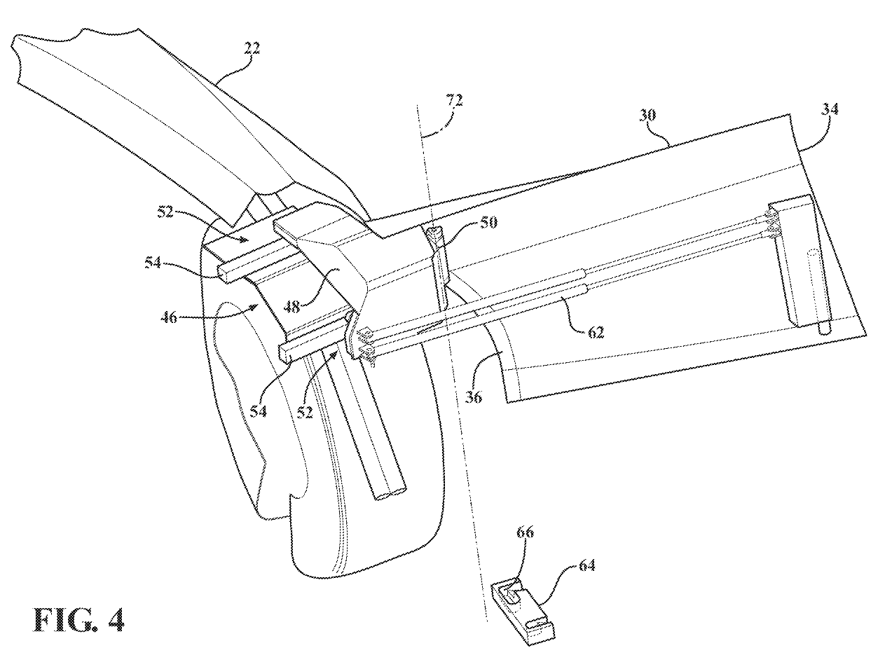

The first door 30 is moveable between a closed position, shown in FIG. 2, an intermediate position, shown in FIG. 3, and an open position, shown in FIG. 4. The first door 30 pivots into the open position in a first pivot direction 42. The second door 32 pivots open in a second pivot direction 44. The second pivot direction 44 is opposite the first pivot direction 42. The first pivot direction 42 includes one of a counterclockwise direction and a clockwise direction, and the second pivot direction 44 includes the other of the counterclockwise direction and the clockwise direction.

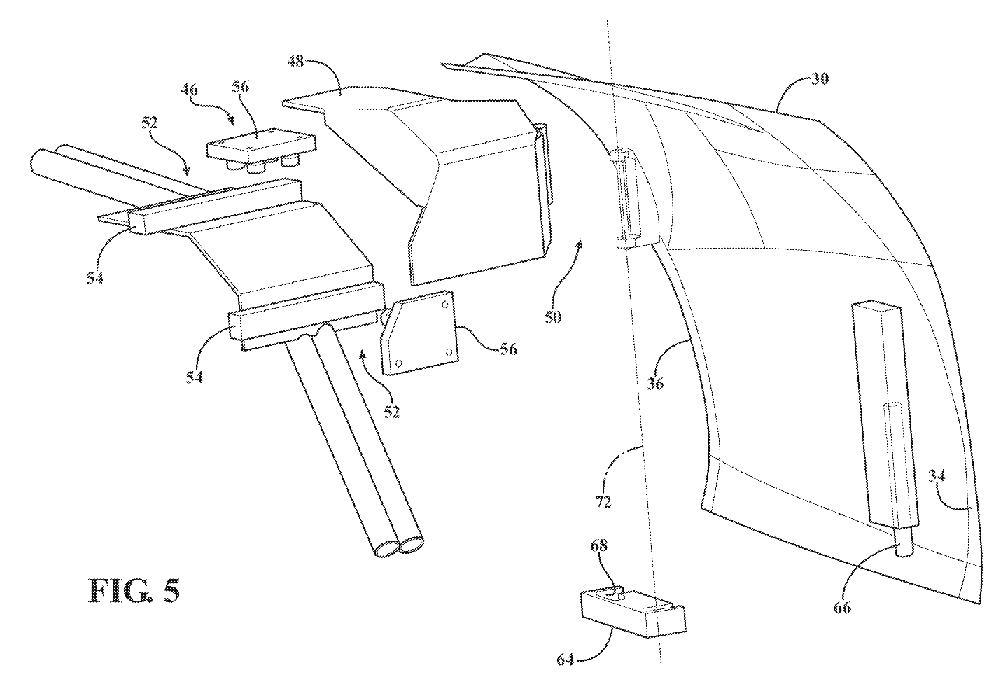

Referring to FIG. 5, the vehicle 20 further includes a hinge assembly 46. The hinge assembly 46 is attached to the body 22, and attaches the first door 30 to the body 22. The hinge assembly 46 is slideably moveable relative to the body 22 in a lateral direction relative to the longitudinal axis 28. As such, the hinge assembly 46 slides substantially perpendicularly relative to the longitudinal axis 28 of the body 22.

The hinge assembly 46 includes a housing 48 supporting the first door 30. The housing 48 supports a hinge 50, which interconnects the first door 30 with the housing 48. The first door 30 is attached to the housing 48 of the hinge assembly 46 adjacent the second edge 36 of the first door 30. The hinge assembly 46 further includes at least one roller assembly 52 coupled to the body 22 and supporting the housing 48. As shown, the hinge assembly 46 includes two roller assemblies 52. However, it should be appreciated that the hinge assembly 46 may incorporate any number of roller assemblies 52. The roller assemblies 52 slideably attach the housing 48 of the hinge assembly 46 to the body 22 of the vehicle 20. As shown, each of the roller assemblies 52 include a slide rail 54 rigidly attached to the body 22, and a roller plate 56 rigidly attached to the housing 48 and slideably attached to the slide rail 54. The roller plate 56 slides across and relative to the slide rail 54. It should be appreciated, that the roller assemblies 52 may be configured in some other manner not described herein that is capable of slideably attaching the housing 48 to the body 22 for lateral movement of the housing 48 relative to the longitudinal axis 28 of the body 22.

The vehicle 20 may further include a hinge assembly actuator (not shown). The hinge assembly actuator interconnects the body 22 and the hinge assembly 46. The hinge assembly actuator is configured for moving the housing 48 of the hinge assembly 46 relative to the roller assemblies 52. The hinge assembly actuator may include, but is not limited to, an electric motor or some other similar device. The vehicle 20 may further include at least one limit switch (not shown) coupled to the hinge assembly actuator. The limit switch is configured to limit movement of the hinge assembly 46 to within a pre-defined range of movement. Accordingly, the limit switch disengages the hinge assembly actuator when the housing 48 of the hinge assembly 46 reaches and activates the limit switch. It should be appreciated that the vehicle 20 may include multiple limit switches. For example, the vehicle 20 may include a first limit switch for limiting the inward movement of the housing 48, and a second limit switch for limiting the outward movement of the housing 48.

The vehicle 20 may further include a door actuator 62. The door actuator 62 interconnects the hinge assembly 46 and the first door 30. The door actuator 62 is configured for pivoting the first door 30 between the intermediate position and the open position. As such, the door actuator 62 causes the first door 30 to swing open in the first pivot direction 42. The door actuator 62 may include, but is not limited to, an electric motor, a spring, a gas piston, or some other similar device.

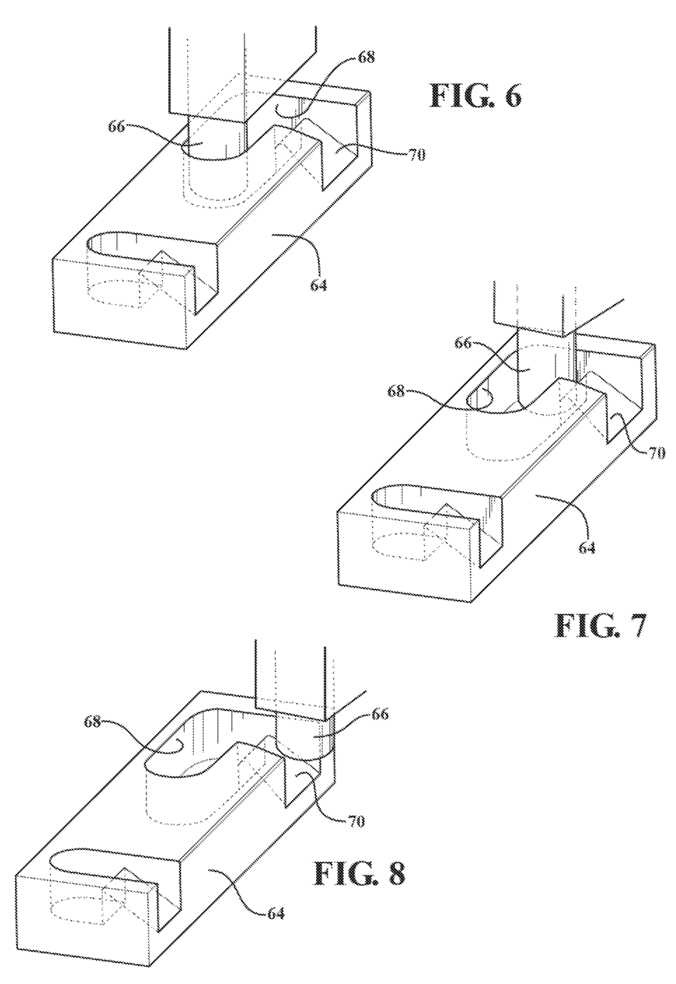

The vehicle 20 further includes a latch guide 64 and a latch pin 66. The latch guide 64 is attached to the body 22, and is disposed adjacent the first edge 34 of the first door 30, at a lower edge of the first door 30. The latch pin 66 is attached to the door, and is moveable between a latched position and an unlatched position. As shown, the latch pin 66 moves vertically between the latched position, shown in FIGS. 6 and 7, and the unlatched position, shown in FIG. 8. When in the latched position, the latch pin 66 engages the latch guide 64 in interlocking engagement to prevent lateral movement of the first edge 34 of the first door 30 relative to the longitudinal axis 28 of the body 22. When in the unlatched position, the latch pin 66 is disengaged from the latch guide 64 to allow lateral movement of the first edge 34 of the first door 30 relative to the longitudinal axis 28 of the body 22.

Referring to FIGS. 6 and 8, the latch guide 64 defines a channel 68 that extends substantially parallel with the longitudinal axis 28 of the body 22. As shown in FIGS. 6 and 7, the latch pin 66 is slideably moveable within the channel 68. Accordingly, when in the latched position, the latch pin 66 may move along the longitudinal axis 28 within the limits of the channel 68. However, the interlocking engagement between the latch pin 66 and the channel 68 prevents the latch pin 66 from moving out of the channel 68 when the latch pin 66 is in the latched position.

The latch guide 64 includes a guide ramp 70. The guide ramp 70 is configured for guiding the latch pin 66 into the channel 68 when the first door 30 is moved from the open position into the intermediate position. The guide ramp 70 may be configured in any suitable manner capable of guiding the latch pin 66 into the channel 68. The latch pin 66 may be spring biased into the latched position, and may be moved into the unlatched position by an electronic latch actuator. However, it should be appreciated that the latch pin 66 may operate in some other manner not described herein.

As described above, the first door 30 moves between the closed position, shown in FIG. 2, the intermediate position, shown in FIG. 3 and the open position, shown in FIG. 4. The first door 30 moves from the closed position, into the intermediate position, and then into the open position in succession when opening the first door 30. The first door 30 moves from the open position, into the intermediate position, and then into the closed position in succession when closing the first door 30.

When the first door 30 is in the closed position, the first door 30 is disposed substantially parallel with the longitudinal axis 28 of the body 22. To open the first door 30, the first door 30 moves from the closed position into the intermediate position. When the first door 30 moves from the closed position into the intermediate position, the second edge 36 of the first door 30 moves laterally relative to the longitudinal axis 28, away from the body 22, and into a pivot position. Additionally, the first edge 34 of the first door 30 moves parallel with the longitudinal axis 28, away from the second door 32 when the first door 30 moves from the closed position into the intermediate position.

The pivot position is the position of the hinge assembly 46 relative to the body 22 that allows the first door 30 to pivot open and closed, without interfering with the second door 32 and/or the body 22. The hinge 50 of the hinge assembly 46 defines a primary pivot axis 72 when in the pivot position. The hinge assembly actuator moves the hinge assembly 46 into and out of the pivot position along the roller assemblies 52. In order to ensure that the first door 30 pivots into the open position only when the hinge assembly 46 is in the pivot position, the latch pin 66 remains disposed in the latched position when the hinge assembly 46 is not in the pivot position.

Once the first door 30 is disposed in the intermediate position, the latch pin 66 is moved into the unlatched position and disengaged from the channel 68 of the latch guide 64. When the first door 30 moves from the intermediate position into the open position, the first door 30 pivots about the primary pivot axis 72 such that the first edge 34 of the first door 30 swings laterally away from the body 22. To close the first door 30, the steps described above for opening the first door 30 are executed in reverse order. In this manner, the first door 30 is moveable between the closed position, the intermediate position and the open position independently of the second door 32.

While the best modes for carrying out the invention have been described in detail, those familiar with the art to which this invention relates will recognize various alternative designs and embodiments for practicing the invention within the scope of the appended claims.

1. A vehicle comprising:
a body;
a hinge assembly attached to the body; and
a first door attached to the hinge assembly and moveable between a closed position, an intermediate position and an open position, the first door including a first edge and a second edge disposed opposite the first edge, with the first door attached to the hinge assembly adjacent the second edge of the first door;
wherein the first door is disposed substantially parallel with a longitudinal axis of the body when in the closed position;
wherein the second edge of the first door moves laterally away from the body into a pivot position and the first edge moves parallel with the longitudinal axis when the first door moves between the closed position and the intermediate position; and
wherein the first door pivots about a primary pivot axis such that the first edge of the first door swings laterally away from the body when the first door moves from the intermediate position into the open position.

2. A vehicle as set forth in claim 1 wherein the hinge assembly is slideably moveable relative to the body in a lateral direction relative to the longitudinal axis.

3. A vehicle as set forth in claim 2 wherein the hinge assembly includes a housing supporting the first door and at least one roller assembly coupled to the body and supporting the housing.

4. A vehicle as set forth in claim 3 wherein the at least one roller assembly includes a slide rail attached to the body and a roller plate slideably attached to the slide rail and attached to the housing.

5. A vehicle as set forth in claim 4 wherein the at least one roller assembly includes two roller assemblies.

6. A vehicle as set forth in claim 1 further comprising a latch guide attached to the body and disposed adjacent the first edge of the first door.

7. A vehicle as set forth in claim 6 further comprising a latch pin attached to the door and moveable between a latched position and an unlatched position, wherein the latch pin engages the latch guide to prevent lateral movement of the first edge of the first door relative to the longitudinal axis of the body when in the latched position, and wherein the latch pin is disengaged from the latch guide to allow lateral movement of the first edge of the first door relative to the longitudinal axis of the body when in the unlatched position.

8. A vehicle as set forth in claim 7 wherein the latch guide defines a channel extending substantially parallel with the longitudinal axis of the body with the latch pin slideably moveable within the channel.

9. A vehicle as set forth in claim 8 wherein the latch pin is disposed in the latched position when the hinge assembly is not in the pivot position.

10. A vehicle as set forth in claim 8 wherein the latch guide includes a guide ramp configured for guiding the latch pin into the channel when the first door is moved from the open position into the intermediate position.

11. A vehicle as set forth in claim 1 wherein the first door moves from the closed position, into the intermediate position, and then into the open position in succession when opening the first door, and wherein the first door moves from the open position, into the intermediate position, and then into the closed position in succession when closing the first door.

12. A vehicle as set forth in claim 1 further comprising a door actuator interconnecting the hinge assembly and the first door and configured for pivoting the first door between the intermediate position and the open position.

13. A vehicle as set forth in claim 15 wherein the door actuator includes one of an electric motor, a gas spring and a hydraulic piston.

14. A vehicle comprising:
a body including a first end and a second end, with the second end disposed opposite the first end along a longitudinal axis of the body;
a hinge assembly attached to the body and slideably moveable relative to the body in a lateral direction relative to the longitudinal axis of the body;
a first door attached to the hinge assembly and moveable between a closed position, an intermediate position and an open position, the first door including a first edge and a second edge disposed opposite the first edge, with the first door attached to the hinge assembly adjacent the second edge of the first door and pivotable in a first pivot direction; and
a second door disposed adjacent the first door and pivotably attached to the body for pivotable movement in a second pivot direction, opposite the first pivot direction;
wherein the second door is disposed nearer the first end of the body than the first door and the first door is disposed nearer the second end of the body than the second door;
wherein the first door are disposed substantially parallel with the longitudinal axis of the body when the first door is in the closed position;
wherein the second edge of the first door moves laterally away from the body into a pivot position and the first edge moves parallel with the longitudinal axis and away from the second door when the first door moves from the closed position into the intermediate position; and
wherein the first door pivots about a primary pivot axis such that the first edge of the first door swings laterally away from the body when the first door moves from the intermediate position into the open position.

15. A vehicle as set forth in claim 14 wherein the hinge assembly includes a housing supporting the first door and at least one roller assembly coupled to the body and supporting the housing.

16. A vehicle as set forth in claim 15 wherein the at least one roller assembly includes a slide rail attached to the body and a roller plate slideably attached to the slide rail and attached to the housing.

17. A vehicle as set forth in claim 14 further comprising a latch guide attached to the body and disposed adjacent the first edge of the door.

18. A vehicle as set forth in claim 17 further comprising a latch pin attached to the door and moveable between a latched position and an unlatched position, wherein the latch pin engages the latch guide to prevent lateral movement of the first edge of the first door relative to the longitudinal axis of the body when in the latched position, and wherein the latch pin is disengaged from the latch guide to allow lateral movement of the first edge of the first door relative to the longitudinal axis of the body when in the unlatched position.

19. A vehicle as set forth in claim 18 wherein the latch guide defines a channel extending substantially parallel with the longitudinal axis of the body with the latch pin slideably moveable within the channel.

20. A vehicle as set forth in claim 19 wherein the latch pin is disposed in the latched position when the hinge assembly is not in the pivot position.
